(19) United States
(12) Patent Application Publication
(10) Pub. No.: US 2004/0260826 A1
(43) Pub. Date: Dec. 23, 2004

(54) Streaming media content purchasing system

(75) Inventor: Mark Andrew Zimmerman, Lake Hiawatha, NJ (US)

Correspondence Address: MARK ZIMMERMAN, 30 A. VICTORIA AVE, LAKE HIAWATHA, NJ, 07034, US

(73) Assignee: Mark Zimmerman, Lake Hiawatha, NJ (US)

(21) Appl. No.: 10/250,244

(22) Filed: Jun. 17, 2003

(51) Int. Cl. G06F 15/16

(52) U.S. Cl. 709/231

(57) ABSTRACT

A System allowing the direct purchase of streaming media content by a Consumer. This System utilizes a Streaming Media Application Feature and a Processing Application to perform the sales transaction with minimal interaction by the Consumer. The Consumer simply tunes in to a media stream (audio or video) through a media device/application, through which they have the ability to purchase the media content directly based on available options.

### DETAILED DESCRIPTION

Currently there are thousands of Servers that stream media broadcasts over the internet or various networks (“Streaming Server(s)”).

Currently there are many applications/programs that allow access to the Streaming Server broadcasts (“Streaming Media Application(s)”).

Currently there are many commercial websites that sell media content (“Commercial Media Server(s)”) in various formats (ie: download of media file over network/internet, shipping of media file on a medium to consumer, etc. . . . ).

Commercial Media Server(s) currently require the Consumer to visit their website or other interactive purchasing system, find the media content they wish to purchase, setup an account, and purchase the media content. The Consumer must know the media content (ex: song, album, video) they wish to purchase or navigate the website or interactive system to find what they want. The Consumer may even need to preview available media samples to determine if they wish to purchase the media content.

The present invention is a System that will utilize a Streaming Server(s) and a Streaming Media Application(s) to allow Consumers to quickly and easily purchase media content, related to the media stream they are tuned to, from a Commercial Media Server(s).

Central to this idea is a Feature of the Streaming Media Application(s) used by the Consumer to tune in to the streaming media. This Feature identifies the current media stream and relays information about the stream and the consumer to a Commercial Media Server(s) based on Consumer interaction or pre-configuration. The Feature can be embedded in a Streaming Media Application or be a plug-in/module to an existing one. The Feature will allow the Consumer to quickly and easily purchase the media content being sent to them by the Streaming Server they are tuned to through the Streaming Media Application.

The Consumer will be able to interact with the Feature to interface with a Commercial Media Server(s) where they can choose purchase options based on the current content of the streaming broadcast. These options can include (but are not limited to) the quantity, quality, delivery method and format of the media selection. The Feature can also be configured so that the Consumer need only perform a simple with the Feature to purchase the current media file.

The activity generated by this invention can be used for a wide variety of data analysis programs like determining popular opinion of media content.

The main benefits of this invention are:

1: The Consumer need not know specific information regarding the media stream they are tuned to but rather they only need to know they are interested in purchasing it.

2: The commercial media distribution process is simplified in that the Consumer can directly purchase the media product and not have to navigate a website or go to a store to purchase the media they want.

3. Streaming Media Servers can be given incentives to broadcast popular media which will generate revenues.

4. Consumers will have a method of legally purchasing the media that is fast and simple.

5. Creators of media content will be able to sell their works more readily.

A Current example of this invention would be a Consumer listening to a streaming radio station would be able to quickly, easily and legally purchase the current song from an online music website by simply pressing a button.

1. A system allowing the direct purchase of streaming media content by a Consumer.

2. Where the streaming media in claim 1 is defined as audio/visual transmissions over a medium allowing Consumers to listen/view the broadcast through a streaming media device/application.

3. Where the Consumer in claim 1 is any end user of such streaming media as defined in claim 2.

4. Where the streaming media device/application in claim 2 is defined as any device or application allowing a Consumer to listen to or view the streaming media broadcast.

5. Where the direct purchase in claim 1 is defined as minimal interaction on the part of the Consumer to transact a purchase of the media content with a media content supplier who in turn delivers the media content to the Consumer.

6. Where the minimal interaction in claim 5 is defined as the Consumer being able to perform one action (like a button push or computer mouse click) to automatically purchase the media content or to be presented with an interface with the ability to process the purchase of the specific media content.

7. Where the delivery of media content in claim 5 can be defined as the direct transfer of the media file over a network (ie: download), the physical shipping of the media content on a preferred medium (like a CD or DVD disc) or any other method of transferring the media content to the consumer on a re-playable format.

8. Where the media content delivered to the Consumer in claim 7 is in a format selected by the Consumer from a list of available media formats for the particular media content purchased.

9. Where the System in claim 1 is comprised of a Consumer interactive Feature of the streaming media device/application and processing system.

10. Where the Feature in claim 9 is defined as a simple user interface built into or around a streaming media device/application allowing for the direct purchase of the media content by the Consumer as defined in claim 5.

11. Where the processing system in claim 9 is an application that will accept the interaction from the Feature in claim 10 and either handle the purchase transaction directly or forward the transaction to another application.

12. Where the application in claim 11 can be standalone or added to an existing media supplier application.

13. Where the presented interface in claim 6 can offer the Consumer options based on the current media stream, show options for similar content and/or be used as a method of drawing the Consumer to the interface where additional purchasing options and advertising is present.

14. Where the automatic purchasing of the media in claim 6 can be a result of the Consumer configuring the feature in the streaming media device/application based on their preferences.
